(19) United States
(12) Patent Application Publication
(10) Pub. No.: US 2025/0174667 A1
(43) Pub. Date: May 29, 2025

(54) NEGATIVE ACTIVE MATERIAL, ELECTROCHEMICAL APPARATUS AND ELECTRONIC APPARATUS

(71) Applicant: Ningde Amperex Technology Limited, Ningde (CN)

(72) Inventors: Duo LI, Ningde (CN); Yafei ZHANG, Ningde (CN)

(73) Assignee: Ningde Amperex Technology Limited, Ningde (CN)

(21) Appl. No.: 19/040,936

(22) Filed: Jan. 30, 2025

Related U.S. Application Data
(63) Continuation of application No. PCT/CN2022/109407, filed on Aug. 1, 2022.

(51) Int. Cl. H01M 4/62; C01B 32/21; H01M 4/02; H01M 4/48

(52) U.S. Cl. CPC H01M 4/625; C01B 32/21; H01M 4/483; C01P 2004/61; C01P 2004/80; C01P 2006/16; C01P 2006/40; H01M 2004/021

(57) ABSTRACT

A negative active material, including a silicon-based material and a sheet-shaped carbon-based material, where the sheet-shaped carbon-based material has a porous structure, a length-to-diameter ratio of the sheet-shaped carbon-based material is greater than or equal to 1.5, Dv50 of the sheet-shaped carbon-based material is 0.5 μm to 25 μm, and a mass percentage of the sheet-shaped carbon-based material is greater than or equal to 10% based on a total mass of the negative active material.

### CROSS REFERENCE OF RELATED APPLICATIONS

The present application is a continuation application of PCT Application PCT/CN2022/109407, filed on Aug. 1, 2022, the content of which is incorporated herein by reference in its entirety

### TECHNICAL FIELD

This application relates to the field of energy storage, and in particular, to a negative active material, an electrochemical apparatus and an electronic apparatus.

### BACKGROUND

Lithium-ion batteries with a high energy density are widely used in some 3C products (such as mobile phones and wristbands). In recent years, the lithium-ion batteries with the high energy density have also been widely used in the electric vehicle industry. These wide range of applications require the lithium-ion batteries to have a high energy density. Silicon has become the most successful high-capacity negative electrode material with its advantages of high gram capacity, and is also the preferred negative electrode material for the next generation of high-performance batteries.

However, as the negative electrode of lithium batteries, silicon materials still face problems such as poor cycle performance and large volume expansion. The theoretical gram capacity of a pure silicon negative electrode can be as high as 4200 mAh/g (45° C.). During full intercalation, the volume of pure silicon particles expands by up to 300%. The huge particle expansion and contraction caused by lithium de-intercalation of the silicon particles will make the silicon particles get rid of the binding of a binder on the silicon particles, resulting in the silicon particles leaving the original position, while destroying a conductive network among the silicon particles, worsening the expansion of the silicon negative electrode, and affecting the cycle performance of a silicon negative electrode battery cell.

At present, it is often used to build a conductive network among silicon particles to improve the cycle performance of the silicon negative electrode battery cell by adding a certain amount of long range and short range conductive agents, such as single-wall CNT, multi-wall CNT, SP, and conductive carbon black, to the formula of a silicon negative electrode plate. However, because the expansion of the silicon negative electrode is too large, when the silicon content of the silicon negative electrode is added to a certain content, it is difficult to build a good conductive network among silicon particles only by adding the conductive agents. Too much conductive additives will affect the solid content of a slurry, prolong the drying time after coating, and worsen its processability. Therefore, new ideas are needed to build a better conductive network among the silicon particles.

### SUMMARY

In view of the problems existing in the prior art, this application provides a negative active material, a preparation method for the negative active material, an electrochemical apparatus and an electronic apparatus including the negative active material, in order to construct a better conductive network among silicon particles, increase the energy density of the electrochemical apparatus, and improve the rate and cycle.

According to a first aspect, this application provides a negative active material, including a silicon-based material and a sheet-shaped carbon-based material, where the sheet-shaped carbon-based material has a porous structure, a length-to-diameter ratio of the sheet-shaped carbon-based material is greater than or equal to 1.5, Dv50 of the sheet-shaped carbon-based material is 0.5 μm to 25 μm, and a mass ratio of the sheet-shaped carbon-based material is greater than or equal to 10% based on a total mass of the negative active material. By the compounding of the porous sheet-shaped carbon-based material and the silicon-based material, a better conductive network among silicon particles can be constructed, and at the same time, the compaction density of an electrode plate and the energy density of a battery cell are increased. In addition, the use of the porous sheet-shaped carbon-based material can increase a transmission channel of Li⁺ in the electrode plate, reduce Rcp, and reduce polarization. The sheet-shaped carbon-based material with the length-to-diameter ratio greater than or equal to 1.5 is more likely to form the conductive network and have smaller ohmic polarization. Too low content of the sheet-shaped carbon-based material will lead to insufficient compaction, the construction of the conductive network is imperfect, and an internal resistance is increased, resulting in increased polarization and low cycle capacity retention rate.

According to some implementations of this application, the negative active material satisfies at least one of following conditions: (i) Dv50 of the sheet-shaped carbon-based material is 5 μm to 25 μm; (ii) the length-to-diameter ratio of the sheet-shaped carbon-based material is 2 to 4.5; (iii) the mass percent of the sheet-shaped carbon-based material is 10% to 45% based on the total mass of the negative active material; or (iv) a pore diameter of the porous structure is 10 nm to 500 nm. Increasing the content of the sheet-shaped carbon-based material can improve compaction, perfect the conductive network, and improve the rate and cycle.

According to some implementations of this application, the negative active material satisfies at least one of following conditions: (v) Dv50 of the sheet-shaped carbon-based material is 10 μm to 20 μm; (vi) the length-to-diameter ratio of the sheet-shaped carbon-based material is 3 to 4.5; (vii) the mass percent of the sheet-shaped carbon-based material is 20% to 40% based on the total mass of the negative active material; or (viii) a pore diameter of the porous structure is 50 nm to 500 nm.

According to some implementations of this application, the negative active material satisfies at least one of following conditions: (ix) Dv50 of the sheet-shaped carbon-based material is 12 μm to 18 μm; (x) a pore diameter of the porous structure is 100 nm to 400 nm; (xi) Dv50 of the silicon-based material is 3 μm to 20 μm; or (xii) the sheet-shaped carbon-based material is selected from at least one of graphite or graphene. The pore diameter of the porous structure in the sheet-shaped carbon-based material is large, which is more conducive to ion transport and better performance.

According to some implementations of this application, the sheet-shaped carbon-based material is a porous sheet-shaped carbon-based material obtained after alkali treatment. According to some implementations of this application, an alkali treatment condition includes at least one of the following: alkali used in alkali treatment is selected from alkali metal hydroxide; alkali treatment time is 0.5 h to 10 h; an alkali treatment temperature is 500° C. to 1200° C.; or a mass ratio of the sheet-shaped carbon-based material to the alkali is 1:1 to 1:10.

According to some implementations of this application, an alkali treatment condition includes at least one of the following: alkali used in alkali treatment is selected from at least one of sodium hydroxide or potassium hydroxide; alkali treatment time is 1 h to 6 h; an alkali treatment temperature is 700° C. to 1000° C.; or a mass ratio of the sheet-shaped carbon-based material to the alkali is 1:1 to 1:10.

According to some implementations of this application, the sheet-shaped carbon-based material is a porous sheet-shaped carbon-based material obtained after alkali treatment, and an alkali treatment condition includes at least one of the following: alkali used in alkali treatment is selected from at least one of potassium hydroxide or sodium hydroxide; alkali treatment time is 1 h to 6 h; an alkali treatment temperature is 700° C. to 1000° C.; or a mass ratio of the sheet-shaped carbon-based material to the alkali is 1:1 to 1:6.

According to a second aspect, this application provides a preparation method for a negative active material, the method including mixing a silicon-based material, a sheet-shaped carbon-based material and an optional conductive agent and binder, where the sheet-shaped carbon-based material has a porous structure, a length-to-diameter ratio of the sheet-shaped carbon-based material is greater than or equal to 1.5, Dv50 of the sheet-shaped carbon-based material is 0.5 μm to 25 μm, and an addition amount of the sheet-shaped carbon-based material is greater than or equal to 10% based on a total mass of the negative active material.

According to some implementations of this application, the sheet-shaped carbon-based material satisfies at least one of following conditions: (a) Dv50 of the sheet-shaped carbon-based material is 5 μm to 25 μm; (b) Dv50 of the silicon-based material is 3 μm to 20 μm; (c) the sheet-shaped carbon-based material is selected from at least one of graphite or graphene; (d) an addition amount of the sheet-shaped carbon-based material is 10% to 45% based on the total mass of the negative active material; or (e) a length-to-diameter ratio of the sheet-shaped carbon-based material is 2 to 4.5. Particles of the sheet-shaped carbon-based material are too small, the conductive network is poorly constructed, and the ohmic polarization is large. Moreover, the BET of small particles is larger, resulting in more side reactions and poor cycle. The particles of the sheet-shaped carbon-based material are large, resulting in small compaction, and the energy density is affected. Moreover, the large particles easily lead to scratches on the coating, therefore processing is difficult.

According to some implementations of this application, the sheet-shaped carbon-based material satisfies at least one of following conditions: (f) Dv50 of the sheet-shaped carbon-based material is 10 μm to 20 μm; (g) the length-to-diameter ratio of the sheet-shaped carbon-based material is 3 to 4.5; or (h) the addition amount of the sheet-shaped carbon-based material is 20% to 40% based on the total mass of the negative active material.

According to some implementations of this application, before mixing, the sheet-shaped carbon-based material is subjected to alkali treatment first, and an alkali treatment condition includes at least one of the following: alkali used in alkali treatment is selected from alkali metal hydroxide; alkali treatment time is 0.5 h to 10 h; an alkali treatment temperature is 500° C. to 1200° C.; or a mass ratio of the sheet-shaped carbon-based material to the alkali is 1:1 to 1:10. According to some implementations of this application, before mixing, the sheet-shaped carbon-based material is subjected to alkali treatment first, and an alkali treatment condition includes at least one of the following: alkali used in alkali treatment is selected from at least one of sodium hydroxide or potassium hydroxide; alkali treatment time is 1 h to 6 h; an alkali treatment temperature is 700° C. to 1000° C.; or a mass ratio of the sheet-shaped carbon-based material to the alkali is 1:1 to 1:6.

When the alkali treatment temperature increases, the pore diameter formed will become larger, which is more conducive to ion transport and better performance. However, if the temperature is too low, the pore diameter will be too small, and the ion transport effect is not good. Too high temperature will destroy the structure of the carbon-based material, resulting in particle breakage. The pore diameter formed will become larger when the alkali treatment time is longer, which is more conducive to ion transport and better performance. If the time is too short, the pore diameter will be too small or no etching will occur, and the ion transport effect is not good. Too long time will destroy the structure of the carbon-based material, resulting in particle breakage. With the increase of the proportion of alkali in alkali treatment, the pore diameter will be larger, which is more conducive to ion transport and better performance. If the proportion of alkali is too small, the pore diameter will be too small or no etching will occur, and the ion transport effect is not good. Excessive alkali will destroy the structure of the carbon-based material, resulting in particle breakage.

According to a third aspect, this application provides an electrochemical apparatus, including a positive electrode and a negative electrode, where the negative electrode includes the negative active material according to the first aspect of this application or a negative active material prepared by the preparation method according to the second aspect of this application.

According to a fourth aspect, this application provides an electronic apparatus, including the electrochemical apparatus according to the third aspect of this application.

According to this application, by the compounding of the porous sheet-shaped carbon-based material and the silicon-based material, a better conductive network among silicon particles can be constructed, and the compaction density of an electrode plate and the energy density of a battery cell are increased. In addition, the use of the porous sheet-shaped carbon-based material can increase a transmission channel of Li⁺ in the electrode plate, reduce Rcp, and reduce polarization.

### DETAILED DESCRIPTION

This application is further elaborated below in combination with the specific implementations. It should be understood that these specific implementations are only used to illustrate this application.

### Negative Active Material

A negative active material provided by this application includes a silicon-based material and a sheet-shaped carbon-based material, where the sheet-shaped carbon-based material has a porous structure, a length-to-diameter ratio of the sheet-shaped carbon-based material is greater than or equal to 1.5, Dv50 of the sheet-shaped carbon-based material is 0.5 μm to 25 μm, and a ratio content of the sheet-shaped carbon-based material is greater than or equal to 10% based on a total mass of the negative active material. By the compounding of the porous sheet-shaped carbon-based material and the silicon-based material, a better conductive network among silicon particles can be constructed, and at the same time, the compaction density of an electrode plate and the energy density of a battery cell are increased. In addition, the use of the porous sheet-shaped carbon-based material can increase a transmission channel of Li⁺ in the electrode plate, reduce Rcp, and reduce polarization. The sheet-shaped carbon-based material with the length-to-diameter ratio greater than or equal to 1.5 is more likely to form the conductive network and have smaller ohmic polarization. Too low content of the sheet-shaped carbon-based material will lead to insufficient compaction density, the construction of the conductive network is imperfect, and an internal resistance is increased, resulting in increased polarization and low cycle capacity retention rate.

According to some implementations of this application, Dv50 of the sheet-shaped carbon-based material is 5 μm to 25 μm. In some embodiments, Dv50 of the sheet-shaped carbon-based material is 5 μm, 10 μm, 15 μm, 17 μm, 20 μm, 22 μm, 25 μm, or a value falling within a range formed by any two of these values. In some embodiments, Dv50 of the sheet-shaped carbon-based material is 10 μm to 20 μm. In some embodiments, Dv50 of the sheet-shaped carbon-based material is 12 μm to 18 μm. In some embodiments, Dv50 of the sheet-shaped carbon-based material is 15 μm to 20 μm.

According to some implementations of this application, Dv50 of the silicon-based material is 3 μm to 20 μm. In some embodiments, Dv50 of the silicon-based material is 3 μm, 5 μm, 8 μm, 10 μm, 12 μm, 15 μm, 18 μm, 20 μm, or a value falling within a range formed by any two of these values.

According to some implementations of this application, the sheet-shaped carbon-based material is selected from at least one of graphite or graphene.

According to some implementations of this application, the mass percent of the sheet-shaped carbon-based material is 10% to 45% based on the total mass of the negative active material. In some embodiments, the mass percent of the sheet-shaped carbon-based material is 10%, 20%, 30%, 35%, 40%, 45% or a value falling within a range formed by any two of these values based on the total mass of the negative active material. Increasing the content of the sheet-shaped carbon-based material can improve compaction density, perfect the conductive network, and improve the rate and cycle. In some embodiments, the mass percent of the sheet-shaped carbon-based material is 20% to 40% based on the total mass of the negative active material. In some embodiments, the mass percent of the sheet-shaped carbon-based material is 25% to 40% based on the total mass of the negative active material. In some embodiments, the mass percent of the sheet-shaped carbon-based material is 30% to 40% based on the total mass of the negative active material.

According to some implementations of this application, the length-to-diameter ratio of the sheet-shaped carbon-based material is 2 to 4.5, for example, 2, 2.3, 2.8, 3.0, 3.3, 3.5, 4, 4.5, or a value falling within a range formed by any two of these values. The sheet-shaped carbon-based material with the length-to-diameter ratio within this range is more likely to form the conductive network, and the ohmic polarization is small. In some embodiments, the length-to-diameter ratio of the sheet-shaped carbon-based material is 2.5 to 4.5. In some embodiments, the length-to-diameter ratio of the sheet-shaped carbon-based material is 3 to 4.5.

According to some implementations of this application, a pore diameter of the porous structure is 10 nm to 500 nm. The pore diameter of the porous structure is 50 nm to 500 nm. In some embodiments, the pore diameter of the porous structure is 20 nm, 50 nm, 80 nm, 100 nm, 110 nm, 130 nm, 150 nm, 180 nm, 200 nm, 220 nm, 250 nm, 280 nm, 300 nm, 320 nm, 350 nm, 400 nm or a value falling within a range formed by any two of these values. The pore diameter of the porous structure in the sheet-shaped carbon-based material is increased, which is more conducive to ion transport and better performance. In some embodiments, the pore diameter of the porous structure is 100 nm to 400 nm. In some embodiments, the pore diameter of the porous structure is 200 nm to 400 nm.

According to some implementations of this application, the sheet-shaped carbon-based material is a porous sheet-shaped carbon-based material obtained after alkali treatment. According to some implementations of this application, alkali used in alkali treatment is selected from alkali metal hydroxide. According to some implementations of this application, alkali treatment time is 0.5 h to 10 h, preferably, 1 h to 6 h. According to some implementations of this application, an alkali treatment temperature is 500° C. to 1200° C., preferably, 700° C. to 1000° C. According to some implementations of this application, a mass ratio of the sheet-shaped carbon-based material to the alkali is 1:1 to 1:10, preferably 1:1 to 1:6, for example, 1:1, 1:2, 1:3, 1:4, 1:5, etc.

### Preparation Method for a Negative Active Material

A preparation method for a negative active material provided by this application includes mixing a silicon-based material, a sheet-shaped carbon-based material and an optional conductive agent and binder, where the sheet-shaped carbon-based material has a porous structure, a length-to-diameter ratio of the sheet-shaped carbon-based material is greater than or equal to 1.5, Dv50 of the sheet-shaped carbon-based material is 0.5 μm to 25 μm, and an addition amount of the sheet-shaped carbon-based material is greater than or equal to 10% based on a total mass of the negative active material.

According to some implementations of this application, Dv50 of the sheet-shaped carbon-based material is 5 μm to 25 μm. In some embodiments, Dv50 of the sheet-shaped carbon-based material is 5 μm, 10 μm, 15 μm, 17 μm, 20 μm, 22 μm, 25 μm, or a value falling within a range formed by any two of these values. In some embodiments, Dv50 of the sheet-shaped carbon-based material is 10 μm to 20 μm. In some embodiments, Dv50 of the sheet-shaped carbon-based material is 12 μm to 18 μm. In some embodiments, Dv50 of the sheet-shaped carbon-based material is 15 μm to 20 μm.

In some implementations, Dv50 of the silicon-based material is 3 μm to 20 μm. In some embodiments, Dv50 of the silicon-based material is 3 μm, 5 μm, 8 μm, 10 μm, 12 μm, 15 μm, 18 μm, 20 μm, or a value falling within a range formed by any two of these values.

In some implementations, the sheet-shaped carbon-based material is selected from at least one of graphite or graphene.

In some implementations, the addition amount of the sheet-shaped carbon-based material is 10% to 45% based on the total mass of the negative active material. In some embodiments, the addition amount of the sheet-shaped carbon-based material is 10%, 20%, 30%, 35%, 40%, 45% or a value falling within a range formed by any two of these values based on the total mass of the negative active material. In some embodiments, the addition amount of the sheet-shaped carbon-based material is 20% to 40% based on the total mass of the negative active material. In some embodiments, the addition amount of the sheet-shaped carbon-based material is 25% to 40% based on the total mass of the negative active material. In some embodiments, the addition amount of the sheet-shaped carbon-based material is 30% to 40% based on the total mass of the negative active material.

In some implementations, the length-to-diameter ratio of the sheet-shaped carbon-based material is 2 to 4.5, for example, 2, 2.3, 2.8, 3.0, 3.3, 3.5, 4, 4.5, or a value falling within a range formed by any two of these values. In some embodiments, the length-to-diameter ratio of the sheet-shaped carbon-based material is 2.5 to 4.5. In some embodiments, the length-to-diameter ratio of the sheet-shaped carbon-based material is 3 to 4.5. Particles of the sheet-shaped carbon-based material are too small, the conductive network is poorly constructed, and the ohmic polarization is large. Moreover, the BET of small particles is larger, resulting in more side reactions and poor cycle. The particles of the sheet-shaped carbon-based material are large, resulting in small compaction density, and the energy density is affected. Moreover, the large particles easily lead to scratches on the coating therefore processing is difficult.

According to some implementations of this application, before mixing, the sheet-shaped carbon-based material is subjected to alkali treatment first, and an alkali treatment condition includes at least one of the following: alkali used in alkali treatment is selected from alkali metal hydroxide; alkali treatment time is 0.5 h to 10 h; an alkali treatment temperature is 500° C. to 1200° C.; or a mass ratio of the sheet-shaped carbon-based material to the alkali is 1:1 to 1:10. According to some implementations of this application, before mixing, the sheet-shaped carbon-based material is subjected to alkali treatment first, and an alkali treatment condition includes at least one of the following: alkali used in alkali treatment is selected from at least one of sodium hydroxide or potassium hydroxide; alkali treatment time is 1 h to 6 h; an alkali treatment temperature is 700° C. to 1000° C.; or a mass ratio of the sheet-shaped carbon-based material to the alkali is 1:1 to 1:10, preferably 1:1 to 1:6, for example, 1:1, 1:2, 1:3, 1:4, 1:5, etc.

The alkali treatment temperature increases, and the pore diameter formed will become larger, which is more conducive to ion transport and better performance; however, the temperature is too low, so the pore diameter will be too small, and the ion transport effect is not good; too high temperature will destroy the structure of the carbon-based material, resulting in particle breakage; the pore diameter formed will become larger when the alkali treatment time is longer, which is more conducive to ion transport and better performance; the time is too short, the pore diameter will be too small or no etching will occur, and the ion transport effect is not good; and too long time will destroy the structure of the carbon-based material, resulting in particle breakage. The proportion of alkali during alkali treatment increases, the pore diameter will become larger, which is more conducive to ion transport and better performance; the proportion of alkali is too small, so the pore diameter will be too small or no etching will occur, and the ion transport effect is not good; and excessive alkali will destroy the structure of the carbon-based material, resulting in particle breakage.

### Electrochemical Apparatus

An electrochemical apparatus provided by this application includes a positive electrode and a negative electrode, where the negative electrode includes the negative active material of this application or a negative active material prepared by the preparation method of this application.

### 1. Negative Electrode

According to implementations of this application, a negative electrode further includes a conductive agent and/or a binder. In some embodiments, the conductive agent includes at least one of conductive carbon black, acetylene black, carbon nanotubes, Ketjen black, conductive graphite, or graphene. In some embodiments, a mass percent of the conductive agent in an active material layer is 0.5% to 10%. In some embodiments, the binder includes at least one of polyvinylidene fluoride, a vinylidene fluoride-hexafluoropropylene copolymer, polyamide, polyacrylonitrile, polyacrylate ester, polyacrylic acid, polyacrylate salt, sodium carboxymethyl cellulose, polyvinylpyrrolidone, polyvinyl ether, polymethyl methacrylate, polytetrafluoroethylene, polyhexafluoropropylene, or styrene-butadiene rubber.

The material, constituents, and manufacturing method of the negative electrode applicable to the embodiments of this application include any technology disclosed in the prior art.

### 2. Positive Electrode

According to some implementations of this application, a positive electrode includes a current collector and a positive active material layer disposed on the current collector. According to some implementations of this application, a positive active material includes, but is not limited to, lithium cobalt oxide (LiCoO₂), Lithium nickel cobalt manganate (NCM), lithium nickel cobalt aluminum, lithium ferrous phosphate (LiFePO₄), or lithium manganese oxide (LiMn₂O₄).

According to some implementations of this application, the positive active material layer further includes a binder, and optionally includes a conductive material. The binder improves bonding between particles of the positive active material and bonding between the positive active material and the current collector. In some implementations, the binder includes: polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly (1,1-difluoroethylene), polyethylene, polypropylene, styrene-butadiene rubber, acrylic styrene-butadiene rubber, epoxy resin, nylon, or the like.

According to some implementations of this application, the conductive material includes, but is not limited to: a carbon-based material, a metal-based material, a conductive polymer, and a mixture thereof. In some embodiments, the carbon-based material is selected from carbon black, acetylene black, Ketjen black, carbon fibers, carbon nanotubes, or any combination thereof. In some embodiments, the metal-based material is selected from metal powder, metal fibers, copper, nickel, aluminum, or silver. In some embodiments, the conductive polymer is a polyphenylene derivative.

According to some embodiments of this application, the current collector may include, but is not limited to, aluminum.

### 3. Electrolyte Solution

An electrolyte solution applicable to the embodiment of this application may be an electrolyte solution known in the prior art.

In some embodiments, the electrolyte solution includes an organic solvent, a lithium salt, and an additive. The organic solvent of the electrolyte solution according to this application may be any organic solvent known in the prior art that can be used as a solvent for the electrolyte solution. An electrolyte used in the electrolyte solution according to this application is not limited and may be any electrolyte known in the prior art. The additive of the electrolyte solution according to this application may be any additive known in the prior art that may be used as an additive for the electrolyte solution.

In some embodiments, the organic solvent includes, but is not limited to: ethylene carbonate (EC), propylene carbonate (PC), diethyl carbonate (DEC), ethyl methyl carbonate (EMC), dimethyl carbonate (DMC), propylene carbonate, or ethyl propionate.

In some embodiments, the lithium salt includes, but is not limited to: lithium hexafluorophosphate (LiPF₆), lithium tetrafluoroborate (LiBF₄), lithium difluorophosphate (LiPO₂F₂), lithium bistrifluoromethanesulfonimide LiN(CF₃SO₂)₂ (LiTFSI), lithium bis(fluorosulfonyl)imide Li(N(SO₂F)₂) (LiFSI), lithium bis(oxalate) borate LiB(C₂O₄)₂ (LiBOB), or lithium difluoro(oxalato) borate LiBF₂(C₂O₄) (LiDFOB).

In some embodiments, a concentration of the lithium salt in the electrolyte solution is about 0.5 mol/L to 3 mol/L, about 0.5 mol/L to 2 mol/L, or about 0.8 mol/L to 1.5 mol/L.

### 4. Separator

A material and shape of a separator used in the electrochemical apparatus of this application are not particularly limited, and may be of any technology disclosed in the prior art. In some embodiments, the separator includes a polymer or an inorganic compound, etc., formed by a material that is stable to the electrolyte solution of this application.

For example, the separator may include a substrate layer and a surface treatment layer. The substrate layer is a non-woven fabric, a film or a composite film with a porous structure, and a material of the substrate layer is selected from at least one of polyethylene, polypropylene, polyethylene terephthalate and polyimide. Specifically, a polypropylene porous film, a polyethylene porous film, a polypropylene non-woven fabric, a polyethylene non-woven fabric or a polypropylene-polyethylene-polypropylene porous composite film may be used.

The surface treatment layer is disposed on at least one surface of the substrate layer. The surface treatment layer may be a polymer layer or an inorganic compound layer, or a layer formed by mixing a polymer and an inorganic compound.

The inorganic substance layer includes inorganic particles and a binder. The inorganic particles are selected from at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, and barium sulfate. The binder is selected from at least one of polyvinylidene fluoride, vinylidene fluoride-hexafluoropropylene copolymer, polyamide, polyacrylonitrile, polyacrylate, polyacrylic acid, polyacrylate, polyvinylpyrrolidone, polyvinyl alcoxyl, polymethyl methacrylate, polytetrafluoroethylene and polyhexafluoropropylene.

The polymer layer includes a polymer, and a material of the polymer is selected from at least one of polyamide, polyacrylonitrile, acrylate polymer, polyacrylic acid, polyacrylate, polyvinylpyrrolidone, polyvinyl alcoxyl, polyvinylidene fluoride, and poly(vinylidene fluoride-hexafluoropropylene).

### Electronic Apparatus

This application further provides an electronic apparatus, including the electrochemical apparatus in the third aspect of this application.

An electronic device or apparatus of this application is not specifically limited. In some embodiments, the electrochemical device of this application includes, but is not limited to, a notebook computer, a pen-input computer, a mobile computer, an electronic book player, a portable phone, a portable fax machine, a portable copier, a portable printer, a headphone, a video recorder, a liquid crystal television, a hand-held cleaner, a portable CD machine, a mini disc, a transceiver, an electronic organizer, a calculator, a memory card, a portable audio recorder, a radio, a backup power supply, an unmanned aerial vehicle, a motor, an automobile, a motorcycle, a power bicycle, a bicycle, a lighting appliance, a toy, a game machine, a clock, an electric tool, a flash light, a camera, a large household storage battery, a lithium-ion capacitor, etc.

This application is further elaborated below with reference to embodiments. It should be understood that these embodiments are only used to illustrate this application and are not intended to limit the scope of this application.

### EMBODIMENT AND COMPARATIVE EMBODIMENT

### Preparation of Porous Flake Graphite

The porous flake graphite is prepared by a KOH etching method. First, uniformly mixing graphite powder and KOH solid powder according to a ratio, heating to 500° C. to 1200° C. under an inert gas environment, preferably heating to 700° C. to 1000° C., the temperature rising rate being 5° C./min, the highest temperature maintaining time being 0.5 h to 10 h, and a mass ratio of graphite to KOH being 1:1 to 1:10; and after reaction is completed, decreasing the temperature to a room temperature, washing to be neutral, and drying at 60° C. to obtain the porous flake graphite.

### Preparation of Lithium-Ion Battery

### Preparation of Negative Electrode:

Adding an acrylonitrile copolymerization LA type water-based electrode binder and deionized water into a planetary mixer to be stirred to prepare a binder solution for static use; adding carbon black Super-p conductive powder and single-arm carbon nanotube suspension emulsion into a planetary ball mill for ball milling and wet mixing; putting the mixed two conductive agents and the negative active material (silicon material and flake graphite) into the planetary mixer for thick mixing; and then adding the binder solution to be mixed and stirred, and finally adding deionized water to stir to adjust the viscosity of a negative slurry. A weight ratio of the negative active material (silicon material and flake graphite) to the binder to the Super-p to the carbon nanotubes is 95:2:2:1. Coating current collector copper foil with the slurry, and drying, cold-pressing, slicing and welding tabs to obtain a negative electrode.

### Preparation of Positive Electrode:

Fully stirring and mixing lithium cobalt oxide (molecular formula being LiCoO₂) as a positive active material, acetylene black as a conductive agent, and polyvinylidene difluoride (PVDF for short) as a binder at a weight ratio of 96:2:2 in a proper amount of N-methyl-pyrrolidone (NMP for short) solvent, and forming a uniform positive electrode slurry. Subsequently, coating current collector aluminum foil with the slurry, and drying, cold pressing, slicing, and welding tabs to obtain a positive electrode.

### Preparation of Electrolytic Solution:

Under a dry argon environment, dissolving lithium salt (LiPF₆) in a non-aqueous solvent formed by mixing ethylene carbonate (EC), propylene carbonate (PC), and diethyl carbonate (DEC), propyl propionate (PP) with a mass ratio of EC:PC:DEC:PP=20:20:40:20, the concentration of lithium salt being 1 M, and adding 1% fluoroethylene carbonate (FEC) to dissolve and mix evenly.

Using a PE porous polymer film as a separator. Stacking a positive electrode plate, the separator, and a negative electrode plate in sequence in such a way that the separator is located between the positive electrode and the negative electrode to serve a purpose of isolation, and then winding to obtain an electrode assembly. Putting the electrode assembly into an outer package, injecting the prepared electrolyte solution, sealing the package, and performing steps such as chemical formation, degassing, and edge trimming to obtain a lithium-ion battery.

For differences in parameters and processes of embodiments and comparative embodiments, refer to Table 1.

### Testing Cycle Performance of Battery:

Putting a lithium-ion battery into an incubator of 25° C./45° C., standing for 20 minutes, and making the lithium-ion battery achieve the constant temperature. Charging the lithium-ion battery to a voltage of 4.45 V at a constant current of 0.7 C and to a current of 0.05 C at a constant voltage, and then discharging to a voltage of 3.0 V at a constant current of 1 C, where this is one charge-discharge cycle. Taking the first discharge capacity of 100%, performing charge-discharge cycles repeatedly, until the discharge capacity fades to 60%, stopping the test, and recording the number of cycles as an indicator for evaluating the cycle performance of the lithium-ion battery.

### Measuring Dv50 of SiOx Particles and Dv50 of Graphite Particles:

Firstly, discharging the lithium-ion battery to 0 V, disassembling the negative electrode plate, peeling the active material from the electrode plate with a scraper, and then performing ultrasonic dispersing on the active material in distilled water, and standing for 24 h; at this time, the active substance being layered; graphite particles floating on the top layer, and SiOx particles being on the bottom layer; repeatedly floating several times to separate the SiOx particles and the graphite particles; obtaining the separated SiOx particles and graphite particles after washing with distilled water and drying. A particle size test method refers to GB/T 19077-2016. The specific process is as follows: weighing 1 g of the sample to be tested to be uniformly mixed with 20 mL of deionized water and trace dispersant, placing the same in an ultrasonic device to be subjected to ultrasonic treatment for 5 min, and then pouring the solution into a sampling system Hydro 2000SM for testing. The test device used is Mastersizer 3000 produced by Malvern Company.

### Measuring Pore Diameter of Porous Flake Graphite:

Selecting 3 to 5 parallel samples for SEM testing, collecting 50 pore diameter data, and taking the average value.

### Test Result

Table 1 shows the effect of a length-to-diameter ratio, Dv50 and mass content of porous flake graphite on the performance of lithium-ion batteries.

TABLE 1

| | Negative active material | | | | | | | | | | | |
|---|---|---|---|---|---|---|---|---|---|---|---|---|
| | Porous flake graphite | | | | | | | | | | Lithium-ion battery | |
| | Alkali treatment condition | | | | | | | Mass | | | Performance | Capacity |
| | | Alkali | | | | | | content | | Negative | of battery cell | retention |
| Embodiment | Mass ratio | treat- | Alkali | | | | | based on | | electrode | Capacity | rate of |
| and | of flake | ment | treat- | | | Length-to- | Pore | negative | SiOx | Negative | retention rate | 500 cycles |
| Comparative | graphite | temper- | ment | | | diameter | diam- | active | Particle | electrode | discharged | discharged |
| Embodiment | to KOH | ature | time | Dv50 | | ratio | eter | material | Dv50 | PD | at 3 C | at 1 C |
| Embodiment 1 | 1:3 | 800° C. | 2 h | 17 | μm | 4 | 50 nm | 20% | 12 μm | 1.5 g/cc | 80% | 78% |
| Embodiment 2 | 1:3 | 850° C. | 2 h | 17 | μm | 2.3 | 70 nm | 20% | 12 μm | 1.5 g/cc | 79% | 82% |
| Embodiment 3 | 1:3 | 700° C. | 3 h | 17 | μm | 4 | 80 nm | 30% | 12 μm | 1.6 g/cc | 85% | 88% |
| Comparative | 1:3 | 800° C. | 2 h | 17 | μm | 4 | 50 nm | 5% | 12 μm | 1.3 g/cc | 65% | 61% |
| Embodiment 1 | | | | | | | | | | | | |
| Comparative | 1:3 | 850° C. | 2 h | 17 | μm | 1.1 | 70 nm | 20% | 12 μm | 1.5 g/cc | 69% | 72% |
| Embodiment 2 | | | | | | | | | | | | |
| Comparative | 1:3 | 850° C. | 2 h | 17 | μm | 1.3 | 70 nm | 20% | 12 μm | 1.5 g/cc | 71% | 76% |
| Embodiment 3 | | | | | | | | | | | | |
| Comparative | 1:5 | 700° C. | 3 h | 0.4 | μm | 3.7 | 80 nm | 30% | 12 μm | 1.6 g/cc | 60% | 54% |
| Embodiment 4 | | | | | | | | | | | | |
| Comparative | 1:5 | 700° C. | 3 h | 30 | μm | 3.5 | 80 nm | 30% | 12 μm | 1.3 g/cc | 67% | 60% |
| Embodiment 5 | | | | | | | | | | | | |
| Comparative | 1:5 | 700° C. | 3 h | 30 | μm | 1.1 | 80 nm | 5% | 12 μm | 1.3 g/cc | 60% | 55% |
| Embodiment 6 | | | | | | | | | | | | |

| | | | | | | | | | | |
|---|---|---|---|---|---|---|---|---|---|---|
| Comparative | Without alkali treatment | 17 | μm | 4 | / | 20% | 12 μm | 1.65 g/cc | 75% | 73% |
| Embodiment 7 | | | | | | | | | | |

As can be seen from data in Table 1: too low content of the graphite will lead to insufficient compaction; the content of the graphite is low, so the construction of the conductive network is not perfect, and the internal resistance is increased, resulting in increased polarization and low cycle capacity retention rate; and increasing the content of the graphite can improve the compaction, perfect the conductive network, and improve the rate and cycle.

The lithium-ions of an electrode plate formed by non-porous graphite have a long transport path, Rcp is large, the capacity retention rate is low under a large rate, and the cycle is deteriorated. After the graphite is etched, the lithium ions can be transported through pores, the path is shortened, Rcp is reduced, and the rate and cycle are improved; and the graphite with the length-to-diameter ratio greater than or equal to 1.5 is more likely to form the conductive network, and the ohmic polarization is small.

Table 2 studies the effect of Dv50 value of porous flake graphite on the performance of lithium-ions, where the alkali treatment conditions of Embodiments 2-1 to 2-7 are the same as those of Embodiment 1.

TABLE 2

| | Negative active material | | | | | | | | Lithium-ion battery | |
|---|---|---|---|---|---|---|---|---|---|---|
| | Porous flake graphite | | | | | | | | Performance | |
| | | | | | Mass | | | | of battery cell | Capacity |
| | | | | | content | | Negative | | Capacity | retention |
| | | | | | based on | | electrode | | retention | rate of |
| | | | Length-to- | | negative | SiOx | Negative | | rate | 500 cycles |
| | | | diameter | Pore | active | Particle | electrode | | discharged | discharged |
| Embodiments | Dv50 | | ratio | diameter | material | Dv50 | PD | | at 3 C | at 1 C |
| Embodiment | 17 | μm | 4 | 50 nm | 20% | 12 μm | 1.5 | g/cc | 80% | 78% |
| 2-1 | | | | | | | | | | |
| Embodiment | 1 | μm | 4 | 50 nm | 20% | 12 μm | 1.65 | g/cc | 61% | 55% |
| 2-2 | | | | | | | | | | |
| Embodiment | 5 | μm | 4 | 50 nm | 20% | 12 μm | 1.6 | g/cc | 70% | 67% |
| 2-3 | | | | | | | | | | |
| Embodiment | 12 | μm | 4 | 50 nm | 20% | 12 μm | 1.55 | g/cc | 78% | 76% |
| 2-4 | | | | | | | | | | |
| Embodiment | 15 | μm | 4 | 50 nm | 20% | 12 μm | 1.55 | g/cc | 81% | 79% |
| 2-5 | | | | | | | | | | |
| Embodiment | 20 | μm | 4 | 50 nm | 20% | 12 μm | 1.5 | g/cc | 79% | 75% |
| 2-6 | | | | | | | | | | |
| Embodiment | 25 | μm | 4 | 50 nm | 20% | 12 μm | 1.5 | g/cc | 70% | 66% |
| 2-7 | | | | | | | | | | |

As can be seen from data in Table 2: particles of the graphite are too small, so the conductive network is poorly constructed, and the ohmic polarization is large; the BET of small particles is larger, resulting in more side reactions and poor cycle; the particles of the graphite are large, resulting in small compaction, and the energy density is affected; and moreover, the large particles easily lead to scratches on the coating, therefore processing is difficult.

Table 3 studies the effect of a length-to-diameter ratio of porous flake graphite on the performance of lithium-ions, where the alkali treatment conditions of Embodiments 3-1 to 3-6 are the same as those of Embodiment 2.

TABLE 3

| | Negative active material | | | | | | | Lithium-ion battery | |
|---|---|---|---|---|---|---|---|---|---|
| | Porous flake graphite | | | | | | | Performance | |
| | | | | Mass | | | | of battery cell | Capacity |
| | | | | content | | Negative | | Capacity | retention |
| | | | | based on | | electrode | | retention | rate of |
| | | Length-to- | | negative | SiOx | Negative | | rate | 500 cycles |
| | | diameter | Pore | active | Particle | electrode | | discharged | discharged |
| Embodiments | Dv50 | ratio | diameter | material | Dv50 | PD | | at 3 C | at 1 C |
| Embodiment | 17 μm | 2.3 | 70 nm | 20% | 12 μm | 1.5 | g/cc | 79% | 82% |
| 3-1 | | | | | | | | | |
| Embodiment | 17 μm | 3.7 | 70 nm | 20% | 12 μm | 1.5 | g/cc | 85% | 85% |
| 3-2 | | | | | | | | | |
| Embodiment | 17 μm | 1.7 | 70 nm | 20% | 12 μm | 1.55 | g/cc | 77% | 77% |
| 3-3 | | | | | | | | | |
| Embodiment | 17 μm | 3.2 | 70 nm | 20% | 12 μm | 1.5 | g/cc | 85% | 84% |
| 3-4 | | | | | | | | | |
| Embodiment | 17 μm | 4.1 | 70 nm | 20% | 12 μm | 1.5 | g/cc | 84% | 83% |
| 3-5 | | | | | | | | | |
| Embodiment | 17 μm | 5.0 | 70 nm | 20% | 12 μm | 1.5 | g/cc | 80% | 79% |
| 3-6 | | | | | | | | | |

As can be seen from data in Table 3: the sheet-shaped carbon-based material with the length-to-diameter ratio within 2 to 4.5 is more likely to form the conductive network, and the ohmic polarization is small.

Table 4 studies the effect of a mass content of porous flake graphite on the performance of lithium-ions, where the alkali treatment conditions of Embodiments 4-1 to 4-6 are the same as those of Embodiment 2.

TABLE 4

| | Negative active material | | | | | | | Lithium-ion battery | |
|---|---|---|---|---|---|---|---|---|---|
| | Porous flake graphite | | | | | | | Performance | |
| | | | | Mass | | | | of battery cell | Capacity |
| | | | | content | | Negative | | Capacity | retention |
| | | | | based on | | electrode | | retention | rate of |
| | | Length-to- | | negative | SiOx | Negative | | rate | 500 cycles |
| | | diameter | Pore | active | Particle | electrode | | discharged | discharged |
| Embodiments | Dv50 | ratio | diameter | material | Dv50 | PD | | at 3 C | at 1 C |
| Embodiment | 17 μm | 4 | 50 nm | 20% | 12 μm | 1.5 | g/cc | 80% | 78% |
| 4-1 | | | | | | | | | |
| Embodiment | 17 μm | 4 | 50 nm | 40% | 12 μm | 1.65 | g/cc | 75% | 73% |
| 4-2 | | | | | | | | | |
| Embodiment | 17 μm | 4 | 50 nm | 15% | 12 μm | 1.5 | g/cc | 76% | 74% |
| 4-3 | | | | | | | | | |
| Embodiment | 17 μm | 4 | 50 nm | 30% | 12 μm | 1.6 | g/cc | 77% | 75% |
| 4-4 | | | | | | | | | |
| Embodiment | 17 μm | 4 | 50 nm | 45% | 12 μm | 1.65 | g/cc | 70% | 70% |
| 4-5 | | | | | | | | | |
| Embodiment | 17 μm | 4 | 50 nm | 50% | 12 μm | 1.65 | g/cc | 65% | 60% |
| 4-6 | | | | | | | | | |

As can be seen from data in Table 4: too low content of the sheet-shaped carbon-based material will lead to insufficient compaction, the construction of the conductive network is not perfect, and the internal resistance is increased, resulting in increased polarization and low cycle capacity retention rate.

Table 5 studies the effect of a pore diameter of porous flake graphite on the performance of lithium-ions, where the Dv50 value, length-to-diameter ratio and mass content based on the negative active material of porous flake graphite and the Dv50 value of SiOx particles of Embodiment 5-1 to Embodiment 5-10 and Comparative Embodiment 5-1 are the same as those of Embodiment 3.

TABLE 5

| | Negative active material | | | | | | Lithium-ion battery | |
|---|---|---|---|---|---|---|---|---|
| | Porous flake graphite | | | | | | Performance | |
| | Alkali treatment condition | | | | | | of battery cell | Capacity |
| | Mass | | | | | Negative | Capacity | retention |
| | ratio of | | | | | electrode | retention | rate of |
| | flake | Alkali | Alkali | | | Negative | rate | 500 cycles |
| | graphite | treatment | treatment | Pore | | electrode | discharged | discharged |
| Embodiments | to KOH | temperature | time | diameter | | PD | at 3 C | at 1 C |
| Embodiment | 1:3 | 700° C. | 3 h | 80 | nm | 1.6 g/cc | 85% | 88% |
| 5-1 | | | | | | | | |
| Embodiment | 1:4 | 900° C. | 1 h | 110 | nm | 1.6 g/cc | 86% | 88% |
| 5-2 | | | | | | | | |
| Embodiment | 1:2 | 800° C. | 3 h | 120 | nm | 1.6 g/cc | 86% | 88% |
| 5-3 | | | | | | | | |
| Embodiment | 1:5 | 900° C. | 3 h | 220 | nm | 1.6 g/cc | 90% | 90% |
| 5-4 | | | | | | | | |
| Embodiment | 1:4 | 900° C. | 4 h | 270 | nm | 1.6 g/cc | 91% | 90% |
| 5-5 | | | | | | | | |
| Embodiment | 1:6 | 800° C. | 3 h | 320 | nm | 1.6 g/cc | 92% | 90% |
| 5-6 | | | | | | | | |
| Embodiment | 2:1 | 800° C. | 3 h | 7 | nm | 1.6 g/cc | 77% | 78% |
| 5-7 | | | | | | | | |
| Embodiment | 1:5 | 400° C. | 3 h | 5 | nm | 1.6 g/cc | 73% | 70% |
| 5-8 | | | | | | | | |
| Embodiment | 1:9 | 900° C. | 3 h | 450 | nm | 1.6 g/cc | 63% | 55% |
| 5-9 | | | | | | | | |
| Embodiment | 1:9 | 900° C. | 4 h | 550 | nm | 1.6 g/cc | 56% | 50% |
| 5-10 | | | | | | | | |

| | | | | | | | |
|---|---|---|---|---|---|---|---|
| Comparative | 1:4 | 900° C. | 1 h | Without | 1.6 g/cc | 75% | 73% |
| Embodiment | | | | etching | | | |
| 5-1 | | | | | | | |

As can be seen from data in Table 5: the alkali treatment temperature increases, and the pore diameter formed after graphite etching will become larger, which is more conducive to ion transport and better performance; however, the temperature is too low, so the pore diameter will be too small, and the ion transport effect is not good; too high temperature will destroy the structure of the graphite, resulting in particle breakage; the pore diameter formed after graphite etching will become larger when the alkali treatment time is longer, which is more conducive to ion transport and better performance; the time is too short, the pore diameter will be too small or no etching will occur, and the ion transport effect is not good; too long time will destroy the structure of the graphite, resulting in particle breakage;

The pore diameter formed after graphite etching will become larger when the KOH proportion for alkali treatment is increased, which is more conducive to ion transport and better performance; the KOH proportion is too low, the pore diameter will be too small or no etching will occur, and the ion transport effect is not good; and too much KOH will destroy the structure of the graphite, resulting in particle breakage.

Table 6 studies the effect of Dv50 of SiOx particles on the performance of lithium-ions, where the alkali treatment conditions of Embodiment 6-1 to Embodiment 6-5 are the same as those of Embodiment 3.

TABLE 6

| | Negative active material | | | | | | | Lithium-ion battery | |
|---|---|---|---|---|---|---|---|---|---|
| | Porous flake graphite | | | | | | | Performance | |
| | | | | Mass | | | | of battery cell | Capacity |
| | | | | content | | | Negative | Capacity | retention |
| | | | | based on | | | electrode | retention | rate of |
| | | Length-to- | | negative | SiOx | | Negative | rate | 500 cycles |
| | | diameter | Pore | active | Particle | | electrode | discharged | discharged |
| Embodiments | Dv50 | ratio | diameter | material | Dv50 | | PD | at 3 C | at 1 C |
| Embodiment | 17 μm | 4 | 80 nm | 30% | 12 | μm | 1.6 g/cc | 85% | 88% |
| 6-1 | | | | | | | | | |
| Embodiment | 17 μm | 4 | 80 nm | 30% | 1 | μm | 1.6 g/cc | 75% | 73% |
| 6-2 | | | | | | | | | |
| Embodiment | 17 μm | 4 | 80 nm | 30% | 30 | μm | 1.3 g/cc | 70% | 70% |
| 6-3 | | | | | | | | | |
| Embodiment | 17 μm | 4 | 80 nm | 30% | 3 | μm | 1.6 g/cc | 77% | 74% |
| 6-4 | | | | | | | | | |
| Embodiment | 17 μm | 4 | 80 nm | 30% | 20 | μm | 1.5 g/cc | 75% | 72% |
| 6-5 | | | | | | | | | |

The above embodiments are only used to illustrate the technical solutions of this application, not for limitation. Although this application is described in detail with reference to the above embodiments, persons of ordinary skill in the art should understand that they can still modify the technical solutions described in the above embodiments, or replace a part or all of the technical features thereof, and these modifications or replacements do not take the essence of the corresponding technical solution out of the scope of the technical solutions in this application.

What is claimed is:

1. A negative active material, comprising a silicon-based material and a sheet-shaped carbon-based material; wherein the sheet-shaped carbon-based material has a porous structure, a length-to-diameter ratio of the sheet-shaped carbon-based material is greater than or equal to 1.5, a Dv50 of the sheet-shaped carbon-based material is 0.5 μm to 25 μm, and a mass percentage of the sheet-shaped carbon-based material is greater than or equal to 10% based on a total mass of the negative active material.

2. The negative active material according to claim 1, wherein the Dv50 of the sheet-shaped carbon-based material is 5 μm to 25 μm.

3. The negative active material according to claim 1, wherein the length-to-diameter ratio of the sheet-shaped carbon-based material is 2 to 4.5.

4. The negative active material according to claim 1, wherein the mass percentage of the sheet-shaped carbon-based material is 10% to 45% based on the total mass of the negative active material.

5. The negative active material according to claim 1, wherein a pore diameter of the porous structure is 10 nm to 500 nm.

6. The negative active material according to claim 1, wherein a Dv50 of the silicon-based material is 3 μm to 20 μm.

7. The negative active material according to claim 1, wherein the sheet-shaped carbon-based material is selected from at least one of graphite or graphene.

8. A preparation method for a negative active material, comprising: mixing a silicon-based material, a sheet-shaped carbon-based material, a conductive agent and a binder; wherein the sheet-shaped carbon-based material has a porous structure, a length-to-diameter ratio of the sheet-shaped carbon-based material is greater than or equal to 1.5, Dv50 of the sheet-shaped carbon-based material is 0.5 μm to 25 μm, and an addition amount of the sheet-shaped carbon-based material is greater than or equal to 10% based on a total mass of the negative active material.

9. The preparation method according to claim 8, wherein the sheet-shaped carbon-based material is a porous sheet-shaped carbon-based material obtained after an alkali treatment, and the alkali treatment satisfy at least one of the following conditions:
an alkali used in the alkali treatment is selected from an alkali metal hydroxide;
an alkali treatment time is 0.5 h to 10 h;
an alkali treatment temperature is 500° C. to 1200° C.; or
a mass ratio of the sheet-shaped carbon-based material to the alkali is 1:1 to 1:10.

10. The preparation method according to claim 8, wherein the preparation method satisfies at least one of the following conditions:
(a) Dv50 of the sheet-shaped carbon-based material is 5 μm to 25 μm;
(b) Dv50 of the silicon-based material is 3 μm to 20 μm;
(c) the sheet-shaped carbon-based material is at least one selected from graphite or graphene;
(d) the addition amount of the sheet-shaped carbon-based material is 10% to 45% based on the total mass of the negative active material; or
(e) the length-to-diameter ratio of the sheet-shaped carbon-based material is 2 to 4.5.

11. An electrochemical apparatus, comprising a positive electrode and a negative electrode, wherein the negative electrode comprises the negative active material; wherein the negative active material comprises a silicon-based material and a sheet-shaped carbon-based material, wherein the sheet-shaped carbon-based material has a porous structure, a length-to-diameter ratio of the sheet-shaped carbon-based material is greater than or equal to 1.5, a Dv50 of the sheet-shaped carbon-based material is 0.5 μm to 25 μm, and a mass percentage of the sheet-shaped carbon-based material is greater than or equal to 10% based on a total mass of the negative active material.

12. The electrochemical apparatus according to claim 11, wherein the Dv50 of the sheet-shaped carbon-based material is 5 μm to 25 μm.

13. The electrochemical apparatus according to claim 12, wherein the Dv50 of the sheet-shaped carbon-based material is 10 μm to 20 μm.

14. The electrochemical apparatus according to claim 11, wherein the length-to-diameter ratio of the sheet-shaped carbon-based material is 2 to 4.5.

15. The electrochemical apparatus according to claim 14, wherein the length-to-diameter ratio of the sheet-shaped carbon-based material is 3 to 4.5.

16. The electrochemical apparatus according to claim 11, wherein the mass percentage of the sheet-shaped carbon-based material is 10% to 45% based on the total mass of the negative active material.

17. The electrochemical apparatus according to claim 11, wherein a pore diameter of the porous structure is 10 nm to 500 nm.

18. The electrochemical apparatus according to claim 17, wherein a pore diameter of the porous structure is 100 nm to 400 nm.

19. The electrochemical apparatus according to claim 11, wherein a Dv50 of the silicon-based material is 3 μm to 20 μm.

20. The electrochemical apparatus according to claim 11, wherein the sheet-shaped carbon-based material is selected from at least one of graphite or graphene.
